(19) United States
(12) Patent Application Publication
(10) Pub. No.: US 2018/0231315 A1
(43) Pub. Date: Aug. 16, 2018

(54) DUST CONDITIONING OF SINTER BAND GASES FOR AN ELECTROSTATIC PRECIPITATOR

(71) Applicant: General Electric Technology GmbH, Baden (CH)

(72) Inventor: Jesper Andreas Olof BACK, Vaxjo (SE)

(21) Appl. No.: 15/751,987

(22) PCT Filed: Sep. 13, 2016
(86) PCT No.: PCT/EP2016/071525

§ 371 Date: Feb. 12, 2018

(30) Foreign Application Priority Data
Sep. 16, 2015 (EP) 15185402.3

(51) Int. Cl. F27B 21/06; B03C 3/017; F27D 17/00; C22B 1/16

(52) U.S. Cl. CPC F27B 21/06; C22B 1/16; F27D 17/008; B03C 3/017

(57) ABSTRACT

A system is provided for improving dust collection efficiency at a sinter band device. The system includes a sinter band with material handling stations and auxiliary equipment operative to sinter a metal or metal ore, a primary electrostatic precipitator operative to remove primary dust from a primary gas stream that has passed through a bed of sintering material on the sinter band, and a secondary dust collection device operative to remove secondary dust from a secondary gas stream emanating from one or more suction points at the material handling stations and the sinter band. The secondary dust has a lower electrical resistivity than the primary dust. A dust transportation line is provided operative to transport secondary dust to the primary gas stream downstream of the sinter band, and injecting it at a position upstream of the primary electrostatic precipitator and/or directly into the precipitator itself.

### TECHNICAL FIELD

This disclosure relates to a method of dust conditioning of sinter band gases for an electrostatic precipitator.

### BACKGROUND OF THE DISCLOSURE

The dust removal from the primary gas of a sinter band with an electrostatic precipitator (ESP) is generally a difficult process, despite the relatively low concentration of dust. This is due to the high electrical resistivity of the dust cake formed on the ESP collecting plates, owing mainly to high amounts of alkali chlorides and hydrocarbons that are present in the dust. In order to compensate for this, the size of the ESP has to be large, but even with increased size it is challenging to accomplish really low emission levels.

FIG. 1 reflects one example of a typical existing sinter band device 100, comprising a sinter band 106 and material handling stations 102, 104, 108, 110 and 112. Also some of the auxiliary equipment is shown, such as suction boxes 202, ventilation hoods 302, 306, 312 and 316, and fans 208 and 326, but for the sake of clarity many other devices have been omitted (e.g., ignition burners, heat recovery systems, safety devices, measurement probes, and the like). The raw materials (e.g., ore, coke and lime) that are to be processed are stored in a stockage 102 (silos or other types of storage vessels). From the stockage 102 the raw materials are fed to a mixing station 104 for blending. Dust generated at the mixing station 104 is collected via a ventilation hood 302 and fed to the secondary gas line 308 (that contains a secondary gas stream) via line 304. The secondary gas line 308 transports the dust laden gas to the secondary dust collection device 324, after which the gases are discharged to the atmosphere through the secondary stack 328. In FIG. 1 the secondary dust collection device 324 is depicted as an ESP, which is the most commonly used device, but it may also be any other type of dust collector (fabric filter, cyclone, and the like).

The raw material is then discharged from the mixing station 104 onto the sinter band 106 where the raw material is ignited and sintered. The sintered material at the end of the sinter band is crushed in a hot screening and crushing device 108 and the dust generated from the crushing is swept up in ventilation hood 306 and transported via lines 308, 310 and 322 to the secondary dust collection device 324 for treatment as detailed above.

The hot screening and crushing device 108 is in operative communication with a cooling device 110 where the temperature of the hot sintered material is reduced. Gas from the cooling process ends up in hood 312 and is transported to the secondary dust collection device 324 via lines 314, 320 and 322. The cooled sintered material is received by a cold screen 112 that discharges the material for onward transportation to, for example, a blast furnace. A ventilation hood 316 collects dust at the cold screen while gas lines 318, 320 and 322 carry the dust laden gas to the secondary dust collection device 324.

Gas and dust generated by the sintering process in the material bed on the sinter band 106 is collected in the suction boxes 202 and transported via a primary gas line 204 to the primary electrostatic precipitator 206, where the dust is collected on the collecting electrodes (collecting plates) of the ESP. The dust laden gas flowing through the primary gas line is termed the primary gas stream. The primary gases are driven via a fan 208 to the primary stack 210 and discharged to the atmosphere. It is to be noted that in the device 100 there is no fluid communication between the primary gas line and the secondary gas line and the dust in the primary gas line does not contact dust from the secondary gas line.

The dust in the primary gas stream in line 204, emanating from the sintering material on the sinter band, typically contains hydrocarbons and alkali chlorides, such that when a dust cake is formed on the collecting plates of the primary electrostatic precipitator 206 it has a very high electrical resistivity which reduces the collection efficiency of the ESP. Attempts have been made to resolve this problem by increasing the size of the ESP. This, however, is very costly and has had limited success. Other solutions to improve the ESP efficiency that have been tried are, for example, microsecond pulsing technology and moving electrode ESPs. These are expensive solutions and the increase in ESP collection efficiency is still uncertain.

It is therefore desirable to develop a method to reduce the electrical resistivity of the dust cake formed on the collecting electrodes in the primary ESP, and associated problems with particle collection efficiency, without any large scale modifications to the process or to the equipment.

### SUMMARY OF THE DISCLOSURE

Disclosed herein is a system for improving dust collection efficiency at a sinter band device, the system comprising a sinter band with material handling stations and auxiliary equipment, operative to sinter a metal or metal ore; a primary electrostatic precipitator operative to remove primary dust from a primary gas stream that has passed through a bed of sintering material on the sinter band; a secondary dust collection device operative to remove secondary dust from a secondary gas stream emanating from one or more suction points at the material handling stations and the sinter band; where the secondary dust has a lower electrical resistivity than the primary dust; and a dust transportation line that is operative to transport secondary dust to the primary gas stream downstream of the sinter band, and injecting it at a position upstream of the primary electrostatic precipitator and/or directly into the precipitator itself.

Disclosed herein too is a system for improving dust collection efficiency at a sinter band device, the system comprising a sinter band with material handling stations and auxiliary equipment, operative to sinter a metal or metal ore; a primary electrostatic precipitator operative to remove primary dust from a primary gas stream that has passed through a bed of sintering material on the sinter band; a storage facility containing conditioning dust; where the conditioning dust has a lower electrical resistivity than the primary dust; and a dust transportation line that is operative to transport conditioning dust from the storage facility to the primary gas stream downstream of the sinter band, and injecting it at a position upstream of the primary electrostatic precipitator and/or directly into the precipitator itself.

Disclosed herein too is a system for improving dust collection efficiency at a sinter band device, the system comprising a sinter band with material handling stations and auxiliary equipment, operative to sinter a metal or metal ore; a primary electrostatic precipitator operative to remove primary dust from a primary gas stream that has passed through a bed of sintering material on the sinter band; a secondary dust collection device operative to remove secondary dust from a secondary gas stream emanating from one or more suction points at the material handling stations and the sinter band; where the secondary dust has a lower electrical resistivity than the primary dust; and a gas duct that is operative to transport a slipstream of the secondary gas stream from a position upstream of the secondary dust collection device to the primary gas stream downstream of the sinter band, and injecting it at a position upstream of the primary electrostatic precipitator and/or directly into the precipitator itself.

Disclosed herein too is a method comprising discharging a primary gas stream that contains a primary dust to a primary electrostatic precipitator; where the primary gas stream has passed through a bed of sintering material on a sinter band; and injecting a dust with lower electrical resistivity than the primary dust into the primary gas stream, producing a mixed suspended dust that minimize problems associated with high resistivity when forming a dust cake on a collecting electrode in the primary electrostatic precipitator.

### BRIEF DESCRIPTION OF THE DRAWINGS

FIG. 1 is a schematic that depicts an existing sinter band device;

FIG. 2A is a schematic of an exemplary sinter band device where the dust collection process of the primary sinter gas in the ESP is improved;

FIG. 2B is another schematic of an exemplary sinter band device where the dust collection process of the primary sinter gas in the ESP is improved;

FIG. 2C is yet another schematic of an exemplary sinter band device where the dust collection process of the primary sinter gas in the ESP is improved; and

FIG. 3 is a graph showing an exemplary calculation of how the dust concentration in the primary ESP behaves with and without implementation of the method indicated in FIG. 2A.

### DETAILED DESCRIPTION

Disclosed herein is a method for conditioning the primary gas stream of a sinter band to increase the efficiency of the downstream electrostatic precipitator. The primary gas, which has been drawn through the material bed on the sinter band, typically contains particles of high electrical resistivity making it difficult to clean the gas in an electrostatic precipitator. The conditioning involves introducing particles of lower electrical resistivity into the primary gas stream, such that the combination of dust particles collected on the plates of the ESP forms a dust cake with significantly reduced electrical resistivity. The lower resistivity of the dust cake on the ESP collecting plates permits the ESP to operate at a high power input without significant back-ionization, thus achieving a high collection efficiency of the ESP.

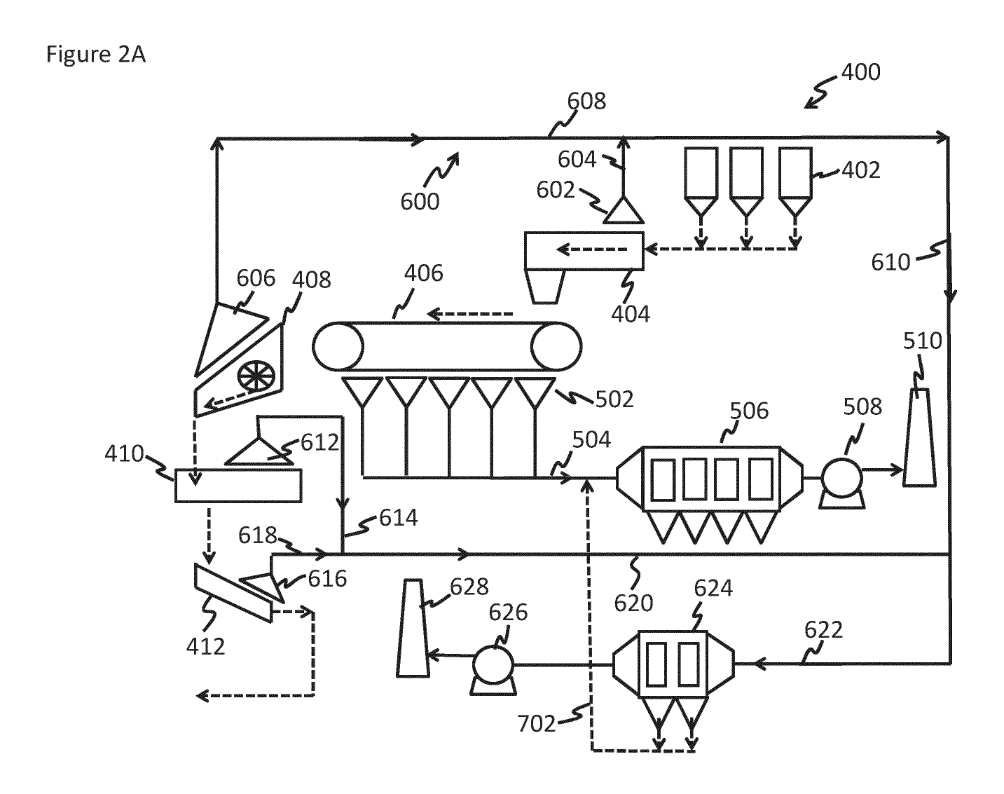

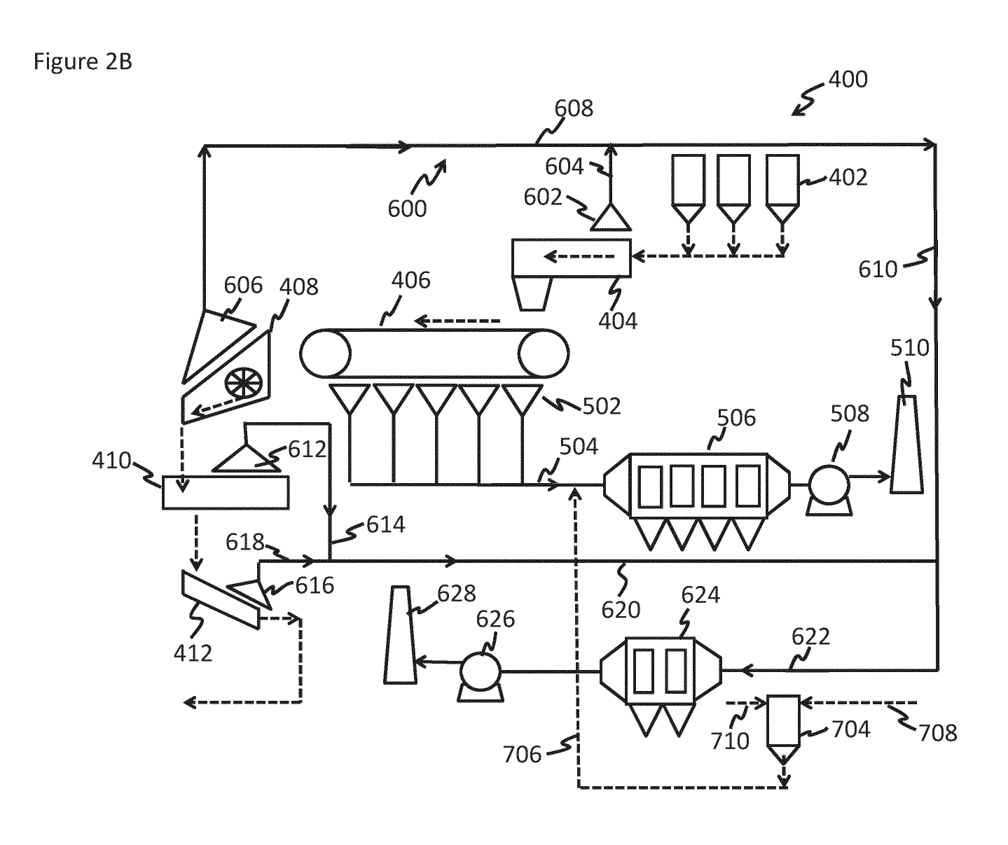

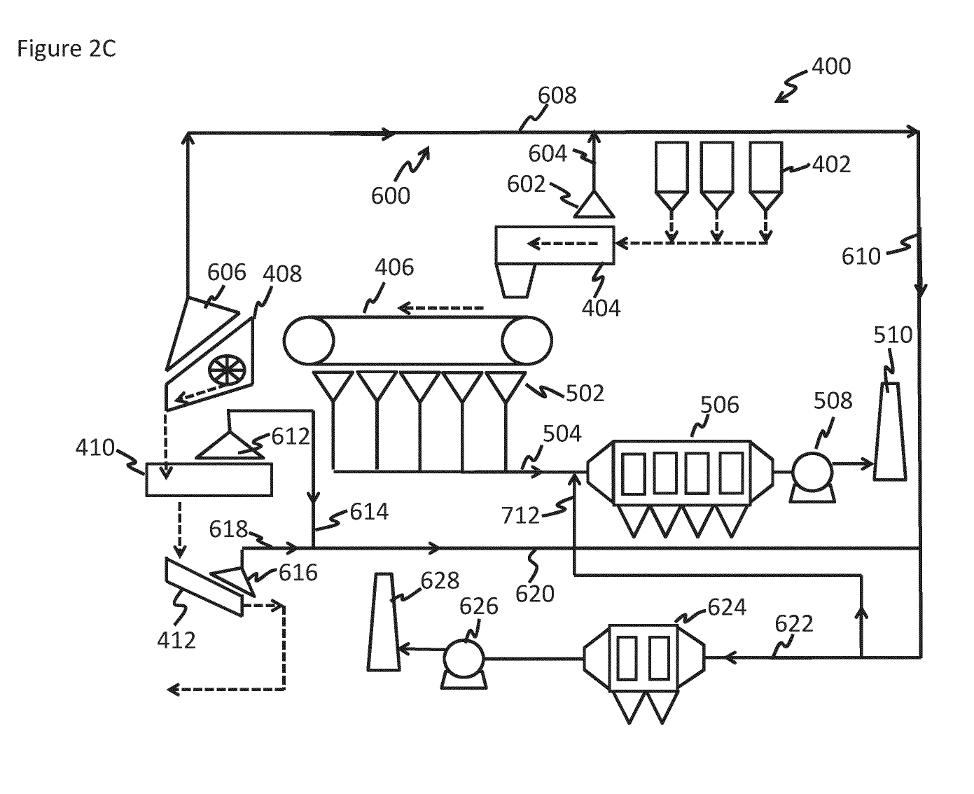

In some embodiments, the dust particles with lower electrical resistivity are supplied to the primary gas stream from the secondary dust collection device. Thus, the low resistivity dust already collected in the secondary dust collection device is injected into the primary gas stream upstream of the primary ESP such that the mix of primary dust and secondary dust in the primary gas stream forms a dust cake of moderate resistivity on the collecting plates in the primary ESP. This is depicted in FIG. 2A and is detailed below.

In other embodiments, the low resistivity particles are supplied to the primary gas stream from an independent silo that has been added to the sinter band device. This is depicted in FIG. 2B and is detailed below. By way of example, the silo that feeds dust to the primary gas stream of the sinter band may contain dust of low electrical resistivity taken from various sources inside the plant where the sinter band is located.

In yet other embodiments, the low resistivity particles needed in the primary ESP are supplied by mixing a slipstream of the dust laden secondary gas stream into the primary gas stream. This is depicted in FIG. 2C and is detailed below. The embodiments can also be combined in different ways, and gas from the secondary gas stream may for example also be used as carrier gas for the dust transportation in embodiments depicted in FIGS. 2A and 2B in lieu of ambient air.

With regard to FIG. 2A, the sinter band device 400 comprises a stockage 402 (e.g., silos or other types of storage vessels) where raw materials (e.g., ore, coke and lime) are stored. The raw materials are then fed to a mixing station 404 for blending. The mixing station 404 lies downstream of the stockage 402. Dust generated at the mixing station 404 is collected via a ventilation hood 602 and fed via gas line 604 to the line 608 that is part of the secondary gas circuit 600 (that contains a secondary gas stream).

The secondary gas circuit 600 comprises lines 604, 608, 610, 614, 618, 620 and 622. The secondary gas, emanating from the suction points represented by the hoods 602, 606, 612 and 616, flows through the secondary gas circuit 600 and passes the secondary dust collection device 624 for dust separation. After cleaning the secondary gas is discharged to the atmosphere through the secondary stack 628 via a fan 626. The dust contained in the secondary gas circuit 600 has a relatively low electrical resistivity. In a preferred embodiment, the dust contained in the secondary gas circuit 600 has a volume resistivity of about 1×1011 Ω/cm (ohm-cm) or less.

With reference now again to FIG. 2A, the mix of raw materials is then discharged from the mixing station 404 on to the sinter band 406 where the material is ignited and sintered. The sintered material is crushed in a hot screening and crushing device 408 which lies downstream of the sinter band 406. Dust generated at the hot screening and crushing device 408 is swept up in a ventilation hood 606 and is transported via lines 608, 610 and 622 to the secondary dust collection device 624.

The crushed material then enters the cooler 410, in which the cooling gas ends up in a hood 612 for onward transfer to the secondary dust collection device 624 via lines 614, 620 and 622. The cooled material is received by a cold screen 412 that discharges the prepared material for further treatment (typically in a blast furnace for reduction to metal). A ventilation hood 616 collects dust at the cold screen and discharges the dust laden gas via lines 618, 620 and 622 to the secondary dust collection device 624.

The dust contaminated gas that has been drawn through the material bed on the sinter band 406 is collected in the suction boxes 502 and discharged via a primary gas line 504 to the primary electrostatic precipitator 506 where the dust is collected on the collecting plates. The dust laden gas flowing through the primary gas line is termed the primary gas stream. Finally, the primary gas is discharged to the atmosphere through the primary stack 510 via fan 508. As detailed earlier, the dust particles in the primary gas stream accumulate on the collecting plates of the primary ESP 506 and cause a build-up of high resistivity dust on the surface of the plates that reduces the efficiency of the primary ESP 506. The main reason for the resistivity problem is that dust in the primary gas that has passed through the material bed on the sinter band contains hydrocarbons and alkali chlorides. The dust generally has an electrical resistivity greater than 1×1012 Ωcm, which is high enough to cause problems with back-ionization in the collected dust layer and significantly reduce the collection efficiency of the primary ESP 506.

In order to prevent the creation of a dust cake with very high resistivity buildup on the ESP collecting plates, a dust with much lower electrical resistivity is mixed into the primary gas stream. A source of particles with low resistivity is the secondary dust collected in the secondary dust collection device from the secondary gas stream. This solution is exemplified in FIG. 2A, where the dust is taken directly from the secondary dust collection device 624 and injected into the primary gas line 504 via the transportation line 702. In the primary gas line 504 the two types of dusts are mixed in a ratio such that the electrical resistivity of the dust cake formed on the plates of the primary ESP 506 becomes sufficiently low for satisfactory ESP operation. When the primary dust is conditioned in this way, alleviating the resistivity problems in the primary ESP, it is suitable to exploit this by manual or automatic changes of the ESP operating parameters (voltage/current limitation, pulsing frequency, rapping repetition times, and the like) to optimize its collection efficiency for the new conditions. Even though FIG. 2A indicates that all of the secondary dust collected in the secondary dust collection device is used for conditioning, it may often be enough to utilize only a part of that dust (e.g., injecting only the finest size fraction of the secondary dust into the primary gas stream).

The dust with low resistivity needed to condition the primary gas may also be taken from other sources inside or outside the integrated plant housing the sinter band. FIG. 2B depicts the principle of this variation. Here the conditioning dust to be injected into the primary gas stream is stored in a silo 704. From the silo 704 the dust it is transported via a feed line 706 to the primary gas line 504 and mixed into the primary gas stream upstream of the primary ESP 506. The dust silo 704 is in turn filled from one or several sources, as indicated by the dust feeding lines 708 and 710. Several potential sources of suitable low resistivity dust are generally available at an integrated plant housing a sinter band, for example secondary ventilation dust, blast furnace flue dust, pelletizing dust, raw material (e.g. ore, coke and lime) and fly ash from power boilers. One special example is of course that the dust silo 704 is fed only with dust from the secondary dust collection device 624. Suitable low resistivity particles of various types may alternatively be sourced from outside the plant, such as for example metallic particles or carbonaceous particles.

Another way to condition the primary gas with low resistivity dust is to directly utilize the suspended particles in the secondary gas stream before they are collected in the secondary dust collection device. As exemplified in FIG. 2C, this can be done by taking a slipstream of the secondary gas stream and mix it into the primary gas stream. In the mixing zone upstream the primary ESP 506, i.e. where the secondary slip stream line 712 meets the primary gas line 504, the gases with their suspended particles are blended, creating a combined dust that will be easy to collect in the primary ESP. In the example shown in FIG. 2C, the slipstream of secondary gas is taken at a point on gas line 622 upstream the secondary dust collection device 624 where all the individual secondary streams have merged, but it should be clear that variants are possible where the gas may be taken instead from e.g. gas stream 604 or 608 (or both). The exact duct arrangement and tapping points of secondary gas will be determined on basis of gas and dust properties in the various gas streams, as well as the layout of the sinter band and relative position of the primary ESP and secondary dust collection device. Various combinations of the principle in FIG. 2C with that in 2A or 2B may also be attractive, such as for example using secondary gas as carrier gas for the dust particles in transport lines 702 or 706, or increasing the dust content in gas stream 712 by injection of dust from the secondary duct collection device 624 or dust silo 704. Another variation of the principles outlined in FIGS. 2A, 2B and 2C is to instead inject the secondary dust or conditioning dust directly into the primary ESP itself, rather than into the upstream gas line.

The amount of low resistivity particles that facilitate the formation of a dust cake with suitable resistivity depends upon the properties (size, shape, electrical resistivity, and the like) of the low resistivity particles from the secondary gas stream versus the properties of the high resistivity particles present in the primary gas stream. In an embodiment, the content of low resistivity particles is greater than 20 wt %, preferably greater than 50 wt % and more preferably greater than 80 wt %, of the total weight of the dust entering the primary ESP 506.

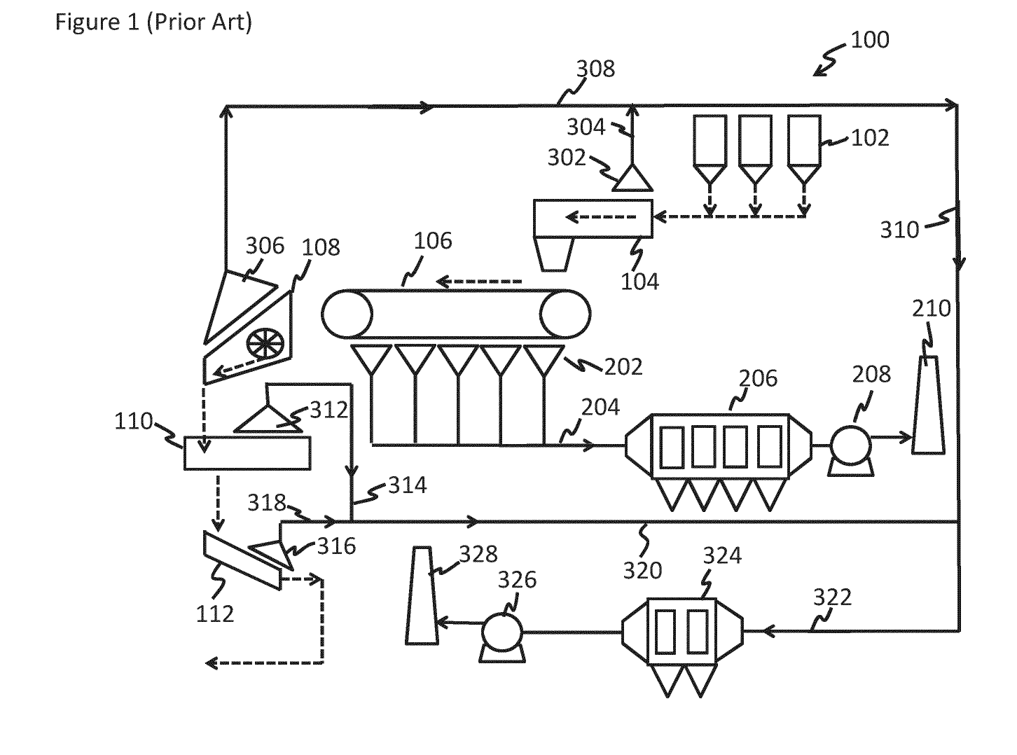

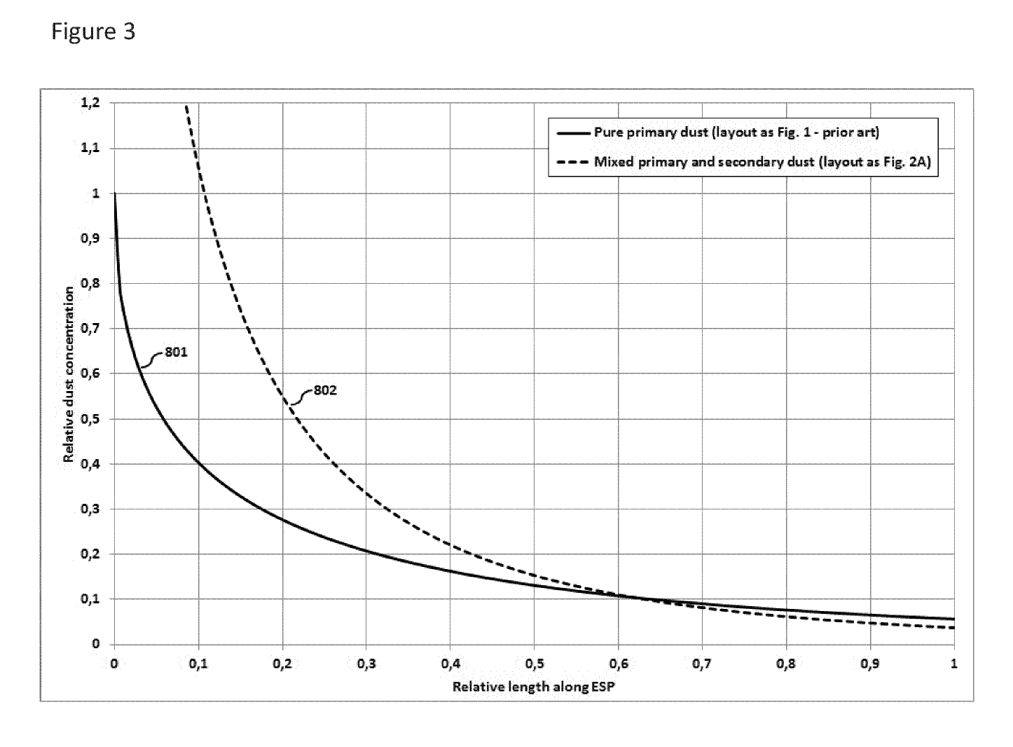

In general, there is a strong non-linear relation between the resulting resistivity of a mixture of dust types and the resistivity and amount of the individual dusts. The key understanding is that the increased ESP performance that can be achieved with lower dust resistivity dominates the increased dust concentration and increased gas flow to the primary ESP. This is demonstrated by the theoretical example in FIG. 3, based on realistic parameters for primary and secondary gas cleaning at a sinter band installation. The two curves in FIG. 3 represent dust concentrations along the length of the primary ESP. The value of the curves at x=0 thus corresponds to the dust concentration at the inlet of the ESP, and the value at x=1 is the dust emission at the ESP outlet. The shape of the curves follows a dampened exponential falloff according to the Matts-Ohnfeldt equation, which is a modified form of the Deutsch equation widely used for evaluating ESP performance. The solid line 801 represents a typical situation in the primary ESP, using the prior art according to FIG. 1. Due to the high resistivity of the dust the exponential falloff of the concentration through the ESP is relatively slow. An estimation of the situation when implementing the disclosure according to FIG. 2A is represented by the dashed curve 802. As per the method in FIG. 2A, low resistivity dust from the secondary dust collection device has been mixed into the primary gas stream, leading to a high concentration of mixed primary/secondary dust at the inlet of the primary ESP. Owing to the much lower resistivity of the dust mixture on the collecting plates, the ESP can be operated at a high power input while avoiding back-ionization in the dust cake. As a consequence, and also because the average particle size in the mixture is larger, the collection efficiency becomes much higher. Despite the significantly higher inlet concentration of the dust mixture compared to the pure primary dust, the resulting concentration at the ESP outlet is about 35% lower. In the example of FIG. 3, it has been assumed that the resistivity of pure primary dust is approximately 5×1013 Ωcm at the conditions prevailing in the primary ESP, while the mix of primary and secondary dust under the same conditions has at least ten times lower resistivity. This is a relatively conservative estimate of the reduction in resistivity.

The presented method of dust conditioning in the primary sinter band gases is advantageous in that it avoids expanding the size of the ESP and consequent costs associated with such an expansion. This design is also advantageous because in existing sinter plants most of the dust collected in both the primary ESP and the secondary dust collection device is typically recycled back to the sinter band feed. Thus there is already some material handling in place, and the dust will still end up in the same place, with the only difference being that the secondary dust takes the path via the primary ESP. This improvement may therefore be performed on existing equipment as a simple retrofit.

Another positive factor that could further increase the perceived positive effect of the method concerns the rapping of the collecting plates. The dust cake formed on the collecting plates, conditioned with the secondary dust, not only obtains a lower electrical resistivity, but also higher density and reduced adhesion force. Both these factors, together with the lower resistivity, enhance the cleaning efficiency of the plates during rapping. The high amount of heavier, metal-rich, particles from the secondary dust thus creates a more porous dust cake with lower adhesion and with higher density that will dislodge easily during rapping. In conventional ESPs for primary gases, the cleaning of the collecting plates has always been a significant problem, which is further accentuated by the long-term increase of resistivity in the precipitated dust layer due to e.g., polarization of alkali chlorides. With the addition of secondary dust to the dust cake the cleaning of the plates of the primary ESP becomes more efficient.

The method of mixing a dust with lower resistivity into a primary dust laden gas stream to alleviate high resistivity problems in a downstream ESP may be advantageously used not only in sinter band devices but also in other processes utilizing ESPs for particle separation (e.g., coal-fired power plants, cement plants, and the like).

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, singular forms like “a” or “an” and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term and/or is used herein to mean both “and” as well as “or”. For example, “A and/or B” may be construed to mean A, B or A and B.

The transition term “comprising” is inclusive of the transition terms “consisting essentially of” and “consisting of” and can be interchanged for “comprising”.

While this disclosure describes exemplary embodiments, it will be understood by those skilled in the art that various changes can be made and equivalents can be substituted for elements thereof without departing from the scope of the disclosed embodiments. In addition, many modifications can be made to adapt a particular situation or material to the teachings of this disclosure without departing from the essential scope thereof. Therefore, it is intended that this disclosure not be limited to the particular embodiment disclosed as the best mode contemplated for carrying out this disclosure.

1. A system for improving dust collection efficiency at a sinter band device, the system comprising:
a sinter band with material handling stations and auxiliary equipment, operative to sinter a metal or metal ore;
a primary electrostatic precipitator operative to remove primary dust from a primary gas stream that has passed through a bed of sintering material on the sinter band;
a secondary dust collection device operative to remove secondary dust from a secondary gas stream emanating from one or more suction points at the material handling stations and the sinter band; wherein the secondary dust has a lower electrical resistivity than the primary dust; and
a dust transportation line that is operative to transport secondary dust to the primary gas stream downstream of the sinter band, and injecting the secondary dust at a position upstream of the primary electrostatic precipitator and/or directly into the primary electrostatic precipitator.

2. The system of claim 1, wherein the secondary dust is present in a concentration of greater than 20 wt %, based on a total weight of dust entering the primary electrostatic precipitator.

3. The system of claim 1, wherein the secondary dust is present in a concentration of greater than 50 wt %, based on a total weight of dust entering the primary electrostatic precipitator.

4. The system of claim 1, where the secondary dust is present in a concentration of greater than 80 wt %, based on a total weight of dust entering the primary electrostatic precipitator.

5. The system of claim 1, where the secondary dust collection device is an electrostatic precipitator.

6. A system for improving dust collection efficiency at a sinter band device, the system comprising:
a sinter band with material handling stations and auxiliary equipment, operative to sinter a metal or metal ore;
a primary electrostatic precipitator operative to remove primary dust from a primary gas stream that has passed through a bed of sintering material on the sinter band;
a storage facility containing conditioning dust; wherein the conditioning dust has a lower electrical resistivity than the primary dust; and
a dust transportation line operative to transport conditioning dust from the storage facility to the primary gas stream downstream of the sinter band, and injecting the conditioning dust at a position upstream of the primary electrostatic precipitator and/or directly into the primary electrostatic precipitator.

7. The system of claim 6, wherein at least some of the conditioning dust comes from secondary ventilation hoods at the material handling stations and the sinter band.

8. The system of claim 6, wherein at least some of the conditioning dust comes from dust sources inside a plant housing the sinter band.

9. The system of claim 6, wherein at least some of the conditioning dust is metallic or carbonaceous.

10. The system of claim 6, wherein the secondary dust is present in a concentration of greater than 20 wt %, based on a total weight of dust entering the primary electrostatic precipitator.

11. The system of claim 6, wherein the secondary dust is present in a concentration of greater than 50 wt %, based on a total weight of dust entering the primary electrostatic precipitator.

12. The system of claim 6, wherein the secondary dust is present in a concentration of greater than 80 wt %, based on a total weight of dust entering the primary electrostatic precipitator.

13. A system for improving dust collection efficiency at a sinter band device, the system comprising:
a sinter band with material handling stations and auxiliary equipment, operative to sinter a metal or metal ore;
a primary electrostatic precipitator operative to remove primary dust from a primary gas stream that has passed through a bed of sintering material on the sinter band;
a secondary dust collection device operative to remove secondary dust from a secondary gas stream emanating from one or more suction points at the material handling stations and the sinter band; wherein the secondary dust has a lower electrical resistivity than the primary dust; and
a gas duct operative to transport a slipstream of the secondary gas stream from a position upstream of the secondary dust collection device to the primary gas stream downstream of the sinter band, and injecting the slipstream at a position upstream of the primary electrostatic precipitator and/or directly into the primary electrostatic precipitator.

14. The system of claim 13, wherein gas flow in the slipstream of the secondary gas stream is greater than 5% of the primary gas stream, based on normalized volumetric flow rate.

15. The system of claim 13, wherein gas flow in the slipstream of the secondary gas stream is greater than 20% of the primary gas stream, based on normalized volumetric flow rate.

16. A method comprising:
discharging a primary gas stream containing a primary dust to a primary electrostatic precipitator; wherein the primary gas stream has passed through a bed of sintering material on a sinter band; and
injecting a dust with lower electrical resistivity than the primary dust into the primary gas stream, producing a mixed suspended dust that minimizes problems associated with high resistivity when forming a dust cake on a collecting electrode in the primary electrostatic precipitator.

17. The method of claim 16, wherein operating parameters of the primary electrostatic precipitator are manually or automatically adjusted to optimize collection efficiency for a situation where the dust on the collecting electrodes has a lower electrical resistivity.
